(19) United States
(12) Patent Application Publication
(10) Pub. No.: US 2017/0115782 A1
(43) Pub. Date: Apr. 27, 2017

(54) COMBINED GRIP AND MOBILITY SENSING

(71) Applicant: Microsoft Technology Licensing, LLC, Redmond, WA (US)

(72) Inventors: Kenneth P. Hinckley, Redmond, WA (US); Hrvoje Benko, Seattle, WA (US); Michel Pahud, Kirkland, WA (US); Dongwook Yoon, Ithaca, NY (US)

(21) Appl. No.: 14/922,033

(22) Filed: Oct. 23, 2015

(51) Int. Cl. G06F 3/041; H04N 5/225; G06K 9/00

(52) U.S. Cl. CPC G06F 3/0412; G06K 9/00335; H04N 5/225; G06F 2203/04104

(57) ABSTRACT

By correlating user grip information with micro-mobility events, electronic devices can provide support for a broad range of interactions and contextually-dependent techniques. Such correlation allows electronic devices to better identify device usage contexts, and in turn provide a more responsive and helpful user experience, especially in the context of reading and task performance. To allow for accurate and efficient device usage context identification, a model may be used to make device usage context determinations based on the correlated gesture and micro-mobility data. Once a context, device usage context, or gesture is identified, an action can be taken on one or more electronic devices.

### BACKGROUND

Electronic devices such as mobile phones, tablets, gaming devices, laptops, computers, smart TVs, etc., are utilized to perform many functions, both individual and collaborative. Such functions can range from reading, browsing, document editing, application usage, etc. Conventional electronic devices, such as tablet computers and mobile phones, maintain their state until the user selects a state change, such as through a user interface element. For example, a user browsing the web on a web browser may select a “reading mode” which eliminates distractions from the device screen. Also, when a user hands a device to another person, the device remains in the same state, and the person temporarily using the device has the same access to all contents and functions on the device as the owner. This opens up potential security vulnerabilities for current devices. Unless the owner of the device takes some precaution through the user interface, nothing prevents the temporary user from viewing content that the owner of the device does not intend him or her to view. Additionally, by waiting for a user selection to initiate a state change, conventional electronic devices are only responsive to specific user selections regarding particular functionalities, and do not themselves anticipate current or future needs of users of the device.

### SUMMARY

This application describes techniques for correlating user grip events with micro-mobility events to support a broad range of interactions and contextually-dependent functionalities. The techniques described herein correlate user grip behavior occurring during individual work, collaboration, multiple-device interactions, etc., with device mobility events, including micro-mobility events, to identify subtle changes in device states. In this way, an electronic device is able to better understand what a user is attempting to do, and in turn may provide a more responsive and helpful user experience.

To allow for accurate and efficient identification of device states, a model may be used for interpreting correlated grip and micro-mobility data. Such a model may be generic, or it may be tailored to one or more users associated with an electronic device. Additionally, the model may be continuously trained utilizing user interactions from one or more electronic devices. Extrinsic sensors such as environmental sensors, wearable sensors, etc., may also be used to more accurately identify the device state of the electronic device. Once a device state is identified, an action can be taken on one or more electronic devices. Such actions may include a user interface action, a system action, an application specific action, etc.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an example environment for utilizing correlated grip/mobility events to support a broad range of interactions and contextually-dependent techniques.

FIG. 2 is a schematic diagram illustrating an example computing system for utilizing correlated grip/mobility events to support a broad design space of interactions and contextually-dependent techniques.

FIG. 3 is flow diagram illustrating a process for utilizing correlated grip/mobility events to support a broad range of interactions and contextually-dependent techniques

FIG. 4 illustrates an example system where correlated grip/mobility events are used to support interactions and contextually-dependent techniques in a single device, multiple user interaction.

FIG. 5 is a flow diagram illustrating a process for utilizing correlated grip/mobility events to support interactions and contextually-dependent techniques in a single device, multiple user interaction.

FIG. 6 illustrates an example system that uses correlated grip/mobility events to support interactions and contextually-dependent techniques in a multiple device, single user interaction.

FIG. 7 is a flow diagram illustrating a process for utilizing correlated grip/mobility events to support interactions and contextually-dependent techniques in a multiple device, single user interaction.

FIG. 8 illustrates an example system where correlated grip/mobility events are used to support interactions and contextually-dependent techniques in a multiple device, multiple user interaction.

FIG. 9 is a flow diagram illustrating a process for utilizing correlated grip/mobility events to support interactions and contextually-dependent techniques in a multiple device, multiple user interaction.

### DETAILED DESCRIPTION

### Overview

This application describes techniques for correlating user grip events associated with an electronic device and mobility events (including micro-mobility events) to provide state changes in a device. By utilizing these techniques, electronic devices are able to deliver a far more natural, more intuitive, more expressive, and more creative way of engaging in individual, collaborative and cross-device work.

The present application describes electronic devices including a variety of sensors (e.g., capacitance sensors, touchscreen sensors, sensors on casings of electronic devices, bezel sensors, hover sensors, proximity sensors, gyroscopes, GPS sensors, accelerometers, cameras, depth cameras, microphones, etc.). The electronic device determines, from sensor output data, a usage context of the electronic device. The usage context includes the external physical state of the electronic device, as opposed to the internal logical state of the device, which includes the state of the processors, memory, and applications executing on the device and so forth. Two electronic devices can have the same internal logical state, but different usage contexts evidenced by the external, physical state of the devices. The usage context is determined from the external, physical state of the device, such as based on motion (mobility), orientation, grip events, and so forth. The usage context may change based on various factors, including based on a user's intentions with respect to the device, including but not limited to indicating an action being performed using the device (either an action to be performed in the physical world, such as handing the device to another person or a computing function, such as carefully reading a document), an action intended to be performed using a different device (such as an intention to cause another device to show content), an action/process being performed by one or more users, etc.

The electronic device may utilize various sensor data to determine one or more user grip events associated with the electronic device. A grip event includes the placement of body parts of user(s) on the device to grasp, hold, balance, position, orient, move, or otherwise manipulate the device in the physical space. This includes placement of fingers and other hand parts on the device, touching the device with arms, chest, or other body parts (for example, balancing a device between arm and torso to carry a device). A grip event may also include sensing when the device rests on the user's lap. Additionally, a grip event may include a user action that does not involve actual contact with the electronic device (i.e., reaching out for the device, hovering over the device, a user gesture, etc.). The location of a user grip event and/or the type of grip employed by the user can reveal user intentions. As such, user grip events represent a rich source of insight into usage context. For example, a user may grip an electronic device proximate to a locus of attention on a display of the device. This might include a user tracking his or her reading position with a thumb, and/or using a partial grip to steer the attention of a second user to a particular location. Moreover, the location of grip events may reflect the physical positioning of one or more users with respect to each other in a physical space, and with respect to the users with respect to the device within a physical space, and/or a nature of collaboration between multiple users. A type of grip employed by a user can also provide information about the usage context. For example, a user may use a particular grip for reading (e.g., a thumb grip), but a different grip for longhand writing (e.g., a tray grip).

Sensor data may also be used to identify mobility events, including micro-mobility events. Mobility includes the often fine-grained orientation and positioning of physical artefacts (e.g., electronic devices). Mobility indicates usage context information, such as personal or shared viewing of content, or steering attention of one's self or others to specific details. For example, a user who is reading an electronic document on an electronic device may slowly tilt the electronic device and/or pull the device closer to his or her eyes as he or she consumes content displayed on the electronic device indicating that the user may be focused on reading a document. The device may then, based on that usage context, change its internal state in some way, such as by eliminating information peripheral to the body texts from a display screen of the device, turning down the volume on audio, turning off low priority reminders, or taking some other action that changes the internal state of the device. In another example, a user may swing an electronic device when attempting to show content on the electronic device to a second user. Likewise, identifying a mobility event, such as a user swinging the device (e.g., passing it from the user to another user), may indicate the usage context of showing content to a second user. In response to identifying this usage context, the device may take some other action to change the internal state of the device. Mobility includes the orientation and/or repositioning of physical artefacts (such as paper documents or electronic devices) to afford shared viewing of content, prevent a sharing of content on the device, take turns operating the device, or to steer the attention of one's self or others to specific details. Additionally, in some examples identifying grip events and/or mobility events may be based on preprogrammed and/or acquired data corresponding to one or more of common grip event sequences, common mobility sequences, and a combination of the two. For example, acquired data associated with a user may describe that when the user grips the device with two hands in portrait mode, and then tilts the tablet, he or she often follows with a one handed grip.

While such grip events and mobility events, including micro-mobility events, may be indicative of specific device usage contexts, the inherent noisiness of sensor data hinders the ability of electronic devices to interpret the sensor data. Moreover, ascribing a specific device usage context to a particular touch, movement, or grip may lead to many false positives, as there may be many reasons that a user touches, moves, or grips the device in a particular way. This increases the difficulty of accurately identifying device usage context. For example, an electronic device may determine from received sensor data that a swing of the electronic device has occurred, but may be unable to determine with sufficient likelihood whether the swing event was due to a user sharing content with a second user, the user storing the electronic device in a storage location (which may be disambiguated using a camera or light sensor), or an unrelated conversational gesture. However, by looking at both user grip events and mobility events, including micro-mobility events, and using the two types of information to reinforce one another, an electronic device is able to identify device usage contexts with a higher degree of statistical certainty.

For example, an electronic device may receive data indicating that the device is slowly being tilted (e.g., it is being rotated about some axis at a rate at or below a threshold rate). Independently, this determination may not provide sufficient certainty about the device usage state. However, when correlated with information that a user of the device is employing a two handed thumb grip, the electronic device may determine that the user is reading content on the electronic device, with the tilting of the electronic device reflecting the progress of the user through the content.

The correlation of grip events and micro-mobility may be performed using a model. The model may match combinations of grip events and mobility data, including micro-mobility data, to a corpus of training data describing what device usage contexts different grips and motions correspond to. In some examples, the combinations of grip events and mobility data may include a series, history, and/or change of one or more grip events and mobility data. The corpus training data may be reflect a general and/or average user, or may be tailored to a specific user. Additionally, the training model may be incrementally and/or iteratively trained and refined based on subsequent user actions and/or feedback. In this way, over time the model may be trained to recognize subtle differences in similar grips/micro-motions, and thus more accurately identify device usage contexts. This iterative learning may also allow the model to learn idiosyncratic habits and actions that are unique to a particular user, social setting, project, collaborative pairing, and/or environment, further enhancing the user experience of electronic devices.

The model can be stored on one or more electronic devices, a server, etc. Accordingly, the correlation and subsequent determination of device usage contexts can be performed by the electronic device, on a separate electronic device, a server, etc., or a combination thereof.

The model may also be trained to accept additional data, such as sensor data from extrinsic sensors, Bluetooth data, user calendar information, meeting invite lists, social media, etc, in order to determine the device usage context. For example, during a video conference, the model may utilize video data from a camera to pair particular users with individual grip events. Also, the model may be trained to accept data from one or more wearable sensors such as rings, watches, bands, biometric sensors etc. to pair grip events with particular users. For example, the model may accept data indicating an invite list to a meeting, wearable technology used by the user, and/or user data specific to a second user with which a user of an electronic device is collaboratively editing a document displayed on the electronic device. The electronic device may then perform an action that changes an internal state of the device, such actions include in various examples, activating a special collaboration system mode, associating individual edits with a user who made them, etc. The model may also accept data indicating the location of the electronic device, or other social, environmental, or cultural differences that cause different correlations of grip events and mobility events to correspond to determine device usage context.

Once the system uses the model to identify a device usage context within a degree of statistical certainty (e.g., a statistical likelihood of the device usage context meeting or exceeding a confidence threshold) an action may be performed on the electronic device. The action may cause a change in the internal state of the computing device. For example, based upon the model identifying that the user is reading a document on an electronic device, an application or operating system of the electronic device may pre-fetch the next page of content so that it is already available when the user selects to proceed to the next page. In another example, when the model determines that a user is sharing particular content proximate to a grip even with a second user, the electronic device may cause that particular content to be highlighted to enhance the sharing experience.

Actions may also include causing a separate electronic device to perform an action. For example, based on determining a device usage context indicating that a user is sharing content with a second user (such as by e.g., physically tilting the device screen towards another user), a second electronic device associated with the second user may display the content. Displaying the content may include modifying the display of the content on the second electronic device (e.g., the content selected by the first user is made to be bold or otherwise be highlighted on the second device). In another example, based on determining a usage context indicating that a user is selecting a portion of content on a first electronic device (such as by e.g., a change of a grip of the user from a full grip located at a first location of the electronic device to a partial grip at a second location of the electronic device proximate to the portion of content), a second electronic device may display the portion of content selected on the first electronic device. The user may then perform actions on the portion of content using the second electronic device, such as creating bookmarks, or adding notations.

The techniques described herein may be implemented in whole or in part by one or more electronic devices. In some examples, certain techniques (or portions thereof) may be implemented at an electronic device associated with a user and/or by another electronic device (e.g., a web service). By way of example and not limitation, illustrative systems and devices suitable for implementing the techniques are described below with reference to the figures.

### Example Architecture

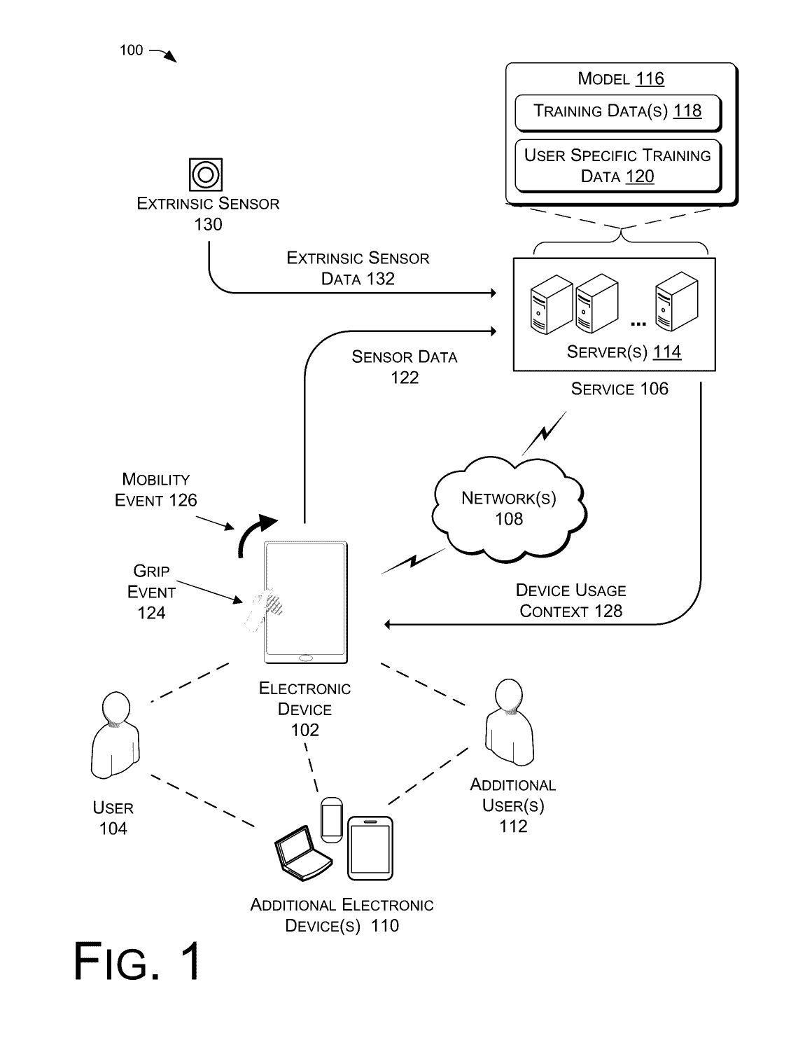

FIG. 1 is a schematic diagram of an example environment 100 that illustrates techniques for utilizing correlated grip/mobility events to support a broad range of interactions and contextually-dependent techniques. Additional details of individual operations illustrated in FIG. 1 and discussed below are described in more detail with reference to subsequent figures.

The environment 100 includes an electronic device 102 which is associated with a user 104. The electronic device 102 may include many different types of electronic devices, including but not limited to, a personal computer, a laptop computer, a tablet computer, a portable digital assistant (PDA), a mobile phone (e.g., a smart phone), an electronic book (e-book) reader, a game console, a set-top box (STB), a smart television (TV), a portable game player, a portable media player, and so forth. The electronic device 102 may be in communication with a service 106 via a network 108 such as, for example, the internet or a local wireless network. The environment 100 further includes one or more additional electronic devices 110 (i.e. laptops, tablets, smartphones, gaming consoles, etc.) associated with the user 104 or one or more additional users 112. The service 106 may be implemented or hosted by one or more servers, server farms, data centers, and/or other computing devices. In the illustrated example, the service 106 is implemented by one or more servers 114.

FIG. 1 illustrates the service 106 hosting a model 116. In some embodiments, the model 116 may be hosted on the electronic device 102, and/or on an additional electronic device 110. Model 116 may be trained to correlate grip events and mobility events associated with the electronic device 102 and/or the additional electronic devices 110, and to determine from this correlation a device usage context (i.e., reading, bookmarking, document editing, collaborative document editing, multi-user meeting, multi-device task performance, information sharing, highlighting, etc.) of the electronic devices 102 and/or the additional electronic devices 110. Model 116 may utilize one or more thresholds related to grip and/or mobility events to determine transitions between device usage contexts (e.g., a tilting of the device greater than 10 degrees, etc.). Such thresholds may be preset, or may be determined based on user settings and/or data driving machine learning approaches.

The service 106 may also store training data 118 that is used to train the model 116 to identify device usage contexts corresponding to different correlations of grip events and mobility events, including micro-mobility events. The service 106 may also store user specific training data 120 that is used to train the model 116 to identify device usage contexts corresponding to different correlations of grip events and mobility events, including micro-mobility events, with relation to one or more particular users. For example, the model 116 may include general training data 118 for generic users of the electronic device 102, and/or one or more corpuses of user specific training data 120 corresponding to known users of the electronic device 102.

The model 116 may be a machine learning model. The model 116 may receive sensor data 122 and other information associated with an electronic device 102 (e.g., subsequent user action, interaction with an additional electronic device 110, etc.), to iteratively learn and refine the device usage contexts. A training module may modify the model based on the sensor data 122 and other information associated with the electronic device (such as by e.g., based upon receiving data indicative of a previously determined device usage context being incorrect, the training module may modify associated training data to minimize similar errors in the future). In this way, a generic corpus of training data 118 can be adapted to a particular electronic device 102, and/or a corpus of training data 118 unique to the particular electronic device 102 may be generated from scratch (e.g., created during an initial training routine/application). In some instances, model 116 may initially determine device user contexts based primarily on thresholds, but may increasingly utilize a machine-learning model as training data 118 is generated.

The training module may also use sensor data 122 and other information associated with a particular user 104 (e.g., user actions of the particular user, the particular user's interaction with an additional electronic device 110, etc.) to generate a corpus of user specific training data 120 for the particular user 104. In this way, over time user specific training data 120 may be built that takes into account idiosyncratic grips and motions that are unique to specific users of an electronic device 102. User specific training data 120 enables the model 116 to determine device contexts with a higher degree of statistical certainty, as the user specific training data accounts for individually specific patterns of grip or mobility actions that are specific to a particular user.

User specific training data 120 may also be exchanged between the service 106, the electronic devices 102 and/or the additional electronic devices 110. For example, when an additional user 112 logs on to, or is otherwise associated with, a new electronic device 102 (e.g., is handed the device, the user of the device is scheduled to meet with the known user, is in the vicinity of the device, etc.), the new electronic device 102 may acquire user specific training data 120 that corresponds to the additional user 112.

FIG. 1 further illustrates an example of a process that may be used to correlate user grip information associated with an electronic device with electronic device mobility, including micro-mobility, to support a broad range of interactions and contextually-dependent techniques. This process may be initiated by one or more sensors (e.g., capacitance sensors, touchscreen sensors, sensors on casings of electronic devices, bezel sensors, hover sensors, proximity sensors, gyroscopes, GPS sensors, accelerometers, cameras, depth cameras, microphones, etc.), providing sensor data. For example, some or all of the sensor data may be associated with a grip event 124 of an electronic device 102. Based upon the sensor data, one or more of the electronic device 102, an additional electronic device 110, and the service 106, identify the occurrence of the grip event 124. Identifying the occurrence of the grip event 124 may include one or more of a determination of a type of grip event (e.g., a thumb grip, a finger grip, a tray grip, etc.). A thumb grip includes a grip that uses the thumb to hold or grasp an object. A finger grip includes a grip that uses fingers, but not the thumb, to hold or grasp an object. A tray grip includes a grip where the user grips an object by resting the object on his or her palm. Moreover, identifying the occurrence of the grip event 124 may include one or more of a determination of a completeness of a grip (e.g., a full handed grip, a partial grip, etc.). A full handed grip may include when a user grips an object using four fingers, where a partial grip may include when the user grips the object with less than four fingers. Identifying the occurrence of the grip event 124 may also include one or more of a determination of a location of the grip (e.g., on the bezel of the device, on a top right corner of the device, covering a portion of a display, etc.). Identifying the occurrence of the grip event 124 may also include identifying multiple grip events based on the sensor data, and/or identifying a change in a grip event 124.

Some or all of the sensor data may also be associated with a mobility event 126, which may include a micro-mobility event. The process may further include, based upon the sensor data, one or more of the electronic device 102, an additional electronic device 110, and the service 106, identifying the occurrence of the mobility event 126. A mobility event 126 may include a rotation, orientation, and/or repositioning of physical artefacts (e.g., electronic devices) during user interaction with the electronic device 102 (e.g., drawing a device closer to a user, swinging a device around an axis, rotating a device, shaking a device, holding a device still, any combinations thereof, etc.). The mobility event 126 may be associated with the electronic device 102, or with an additional electronic device 110.

In FIG. 1, the sensor data 122 is provided by one or more of the electronic device 102 and additional electronic devices 110 to the service 106. The service 106 then uses the sensory data to identify one or more grip events 124 and mobility events 126. As discussed above, these determinations can also be made on the electronic device 102, and/or an additional electronic device 110. The service 106 then correlates the grip events 124 and the mobility events 126 (e.g., by location, time, order, etc.). The service 106 may then use general training data 118 and/or user specific training data 120 to determine a device usage context 128 associated with a correlated grip/mobility event. For example, based on capacitance sensor data paired with accelerometer data from an electronic device 102, and further paired with camera data recognizing a user's face, the service 106 may determine that a bimanual (two handed) grip of an electronic device 102 correlated with the device slowly being drawn to a user's face after a prolonged period of stillness corresponds to a device usage context where the user is closely examining a portion of content during a prolonged reading session. In another example, the service 106 may determine that a change of the above bimanual grip event such that one of the grip events changes location and becomes a partial grip event when correlated with a gradual tilting of the electronic device 102 corresponds to a device usage context 128 where a user 104 is identifying a portion of content that the user may wish to return to during a reading session. The service 106 may also determine the device usage context 128 based on additional information such as a time of day, location of the device, user profile information, a calendar of a user, content on the device, etc. For example, the service 106 may consider the particular content on the device and profile information to determine that a tilting of the device does or does not correspond to a user reading the particular content (i.e., by determining, based on a complexity of the particular content and a normal reading velocity of the user, a rate of tilting that the user would be expected to exhibit when reading the particular content, and then comparing the determined rate of tiling to a detected tilting). The correlation and determination of device usage context 128 can also be made on the electronic device 102, and/or an additional electronic device 110.

One or more extrinsic sensor(s) 130 (e.g., environmental sensors, external cameras, microphones, GPS sensors, wearable sensors, etc.) may provide extrinsic sensor data 132. In some cases, the determination of device usage context 128 may be further based upon the extrinsic sensor data. For example, an electronic device 102 may determine a user 104 and an additional user 112 are collaboratively editing a document on the electronic device 102 based on a correlated grip/mobility event (such as by e.g., the user 104 and the additional user 112 each gripping the electronic device 102 in separate territorial locations of the electronic device 102 combined with a prolonged stillness of the electronic device 102). The electronic device may further determine an identity of the additional user based upon data from a wearable sensor (e.g., smart watch) worn by the additional user 112. A more nuanced action can then be performed, such as causing edits made by the additional user 112 to be assigned to his or her particular user account. The identification may also be performed purely based upon a correlated grip/mobility event (such as by e.g., based on idiosyncratic grip behavior exhibited by the additional user that has been learned by the model 116). The determination of device usage context 128 may be further based on other extrinsic data such as Bluetooth data, user calendar information, meeting invite lists, social media, etc.

The process of FIG. 1 may further include causing an action to be performed on one or more of the electronic device 102 and/or an additional electronic device 110, based on the device usage context 128. Potential actions may include a change in the internal state of the device, such as, a user interface action, a system action, an application specific action, etc. For example, based upon the device usage context 128 of a user 104 examining a portion of content, the electronic device 102 may cause a graphical user interface (GUI) to be displayed on the electronic device 102 to emphasize the content (i.e., highlight, enlarge, remove aspects of the GUI that are unrelated to the content, etc.). Alternatively or in addition, based upon the device usage context 128 of a user 104 examining a portion of content, the electronic device 102 may cause an additional electronic device 110 (such as a television, monitor, tablet device) to display and/or emphasize the content. In another example, based on a device usage context 128 of a content reading session, an electronic device 102 may cause a next portion of the content being read to be pre-fetched, so that it is more quickly available to the user 104. In another example, based on a device usage context 128 of a user 104 showing content on an electronic device 102, one or more additional electronic devices 110 may display the content. In some instances the one or more electronic devices 110 may be selected based upon one or more of a proximity to the electronic device 102, an orientation of the electronic device 102, security and/or access rights of the one or more electronic devices 110, a location in a particular area relative to the electronic device 102, being associated with additional users 112 on a meeting invite list, an identification of one or more additional users 112 facing the display of the electronic device 102, etc.

Once an action has been performed, the electronic device 102 may receive a user action (e.g., a cancellation of the action, use of the action, etc.). This user action may subsequently be used to train the model.

### Example System Utilizing Correlated Grip/Mobility Events

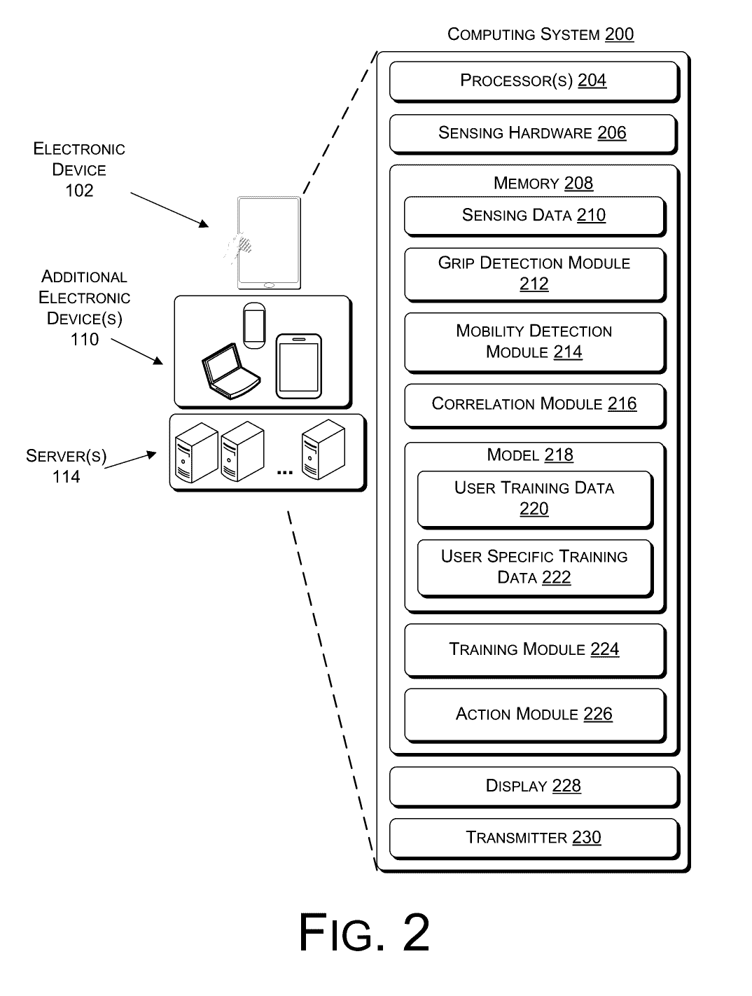

FIG. 2 is a schematic diagram illustrating an example system 200 for utilizing correlated grip/mobility events to support a broad design space of interactions and contextually-dependent techniques. FIG. 1 illustrates a generalized system and conceptual flow of operations including the determining of grip events and mobility events, correlation of grip/mobility events, determination of a device usage context, and subsequent performance of an action. FIG. 2 illustrates additional details of hardware and software components that may be used to implement such techniques. The computing system 200 may include one or more of an electronic device 102, an additional electronic device(s) 110, and/or one or more servers 114. Additionally, individual hardware and software components illustrated in FIG. 2 may be exist in one or more of the electronic device 102, an additional electronic device(s) 110, and/or one or more servers 114. Accordingly, unless otherwise specified, any action or step attributed to any individual hardware or software component may be performed by that component on one or more of the electronic device 102, an additional electronic device(s) 110, and/or one or more servers 114. The system 200 is merely one example, and the techniques described herein are not limited to performance using the system 200 of FIG. 2.

In the example of FIG. 2, the computing system 200 includes one or more processors 204, sensing hardware 206, and memory 208 communicatively coupled to the processor(s) 204. FIG. 2 shows representative electronic device 102 in the forms of a tablet computer. However, this is merely an example, and the electronic device 102 according to this application may take other forms.

The sensing hardware 206 may include one or more of capacitance sensors, touchscreen sensors, sensors on casings of electronic devices, bezel sensors, hover sensors, proximity sensors, gyroscopes, GPS sensors, accelerometers, digital magnetometers, cameras, depth cameras, microphones, etc. The sensing hardware 206 responds to physical stimuli (including for example inertial/rotational motion changes, capacitive/pressure/mechanical changes indicating touch, incident light, sounds, etc.) in part by producing electronic or optical signals or commands which are provided to an I/O interface of the electronic device 102; the I/O interface is coupled to the processors. Data indicating the electronic/optical signals or commands are stored in a data structure (such as in a memory location or a processor register). Receipt of the electronic/optical signal may result in an interrupt event, which the processor and/or an OS of the system responds to by storing the data indicating the electronic/optical signals in the memory 208 and providing one or more pointers, parameters, etc. to the data indicating the electronic/optical signals to one or more of the grip detection module 212, the mobility detection module 214, the correlation module 216, and/or the training module 224. These modules are passed an execution thread, and utilize the pointer(s), parameters, etc. to read the data indicating the electronic/optical signal from the memory 208, and process the data to determine grip events, mobility events, device usage contexts, and take actions, as described in this Detailed Description.

The computing system 200 may include a grip detection module 212, a mobility detection module 214, a correlation module 216, a model 218 including user training data 220 and/or user specific training data 222, a training module 224, and an action module 226 stored in the memory 208. The grip detection module 212 may be executable by the one or more processors 204 to cause one or more processors 204 to perform a determination of a grip event 124 based at least in part upon the sensor data. Determining the occurrence of the grip event 124 may include one or more of a determination of a type of grip event (e.g., a thumb grip, a finger grip, a tray grip, etc.), a completeness of a grip (e.g., a partial grip, a full handed grip, pressure grip, etc.), and a location of the grip (e.g., on the bezel of the device, on a top right corner of the device, covering a portion of a display, etc.). Identifying the occurrence of the grip event 124 may also include identifying multiple different grip events, where the multiple different grip events may occur at the same time or at different times. Identifying the occurrence of the grip event 124 may also include identifying a change in a grip event over time based on the sensor data 210. Identifying the occurrence of the grip event 124 may also include pre-processing of raw sensing data 210 for reducing signal noise using temporal/spatial noise filtering techniques. The noise reduction techniques may can include but will not be restricted to low pass filtering, vision-based image smoothing, the Kalman-filter, etc.

The mobility detection module 214 may be executable by the one or more processors 204 to cause one or more processors 204 to perform a determination of a mobility event 126 based at least in part upon the sensor data 210. Determining the occurrence of the mobility event 126 may include determining a rotation and/or repositioning of the electronic device 102 during a user interaction with the electronic device 102 (e.g., drawing a device closer to a user, swinging a device around an axis, rotating a device, shaking a device, holding a device still, any combinations thereof, etc.). The mobility event 126 may be associated with the electronic device 102, or with one or more additional electronic devices.

The correlation module 216 may be executable by the one or more processors 204 to cause one or more processors 204 to perform a correlation of one or more grip events 124 with one or more mobility events 126 (e.g., by location, time, order, etc.). In some examples, the correlation the one or more grip events 124 with one or more mobility events 126 may include a series of and/or change in one or more of grip events, mobility events, and a combination of the two. The correlation module 216 may utilize model 218 to determine a device usage context associated with a correlated grip/mobility event. For example, the correlation module 216 may utilize model 218 to determine that statistical likelihood that a correlated grip/mobility event corresponds to a particular device usage context meets or exceeds a confidence threshold. The model 218 may determine the statistical likelihood based at least in part on the sensor data 210, and one or more of user training data 220 and/or user specific training data 222. User training data 220 may store data indicating grip events motion events, device usage context with relation to generic users, and may provide other modules (i.e., the action module, the correlation module, etc.), with pointers, parameters, etc. to this data. Likewise, user specific training data 222 may store data indicating grip events motion events, device usage context with relation to particular users, and may provide other modules (i.e., the action module, the correlation module, etc.), with pointers, parameters, etc. to this data.

For example, the correlation module 216 may determine from capacitance sensor data paired with accelerometer data that a bimanual (two handed) grip of an electronic device 102 correlated with a flip motion and/or a rapid shake movement corresponds to a device usage context where the user is trying to proceed to different content (similar to the process of flipping through content using a traditional notebook/notepad/rolodex etc.). In another example, the correlation module 216 may determine from capacitance sensor data paired with accelerometer data that a change of a bimanual grip event such that one of the two grip events changes location and becomes a partial grip event, when correlated with a prolonged stillness of the electronic device 102 corresponds to a device usage context where a user is identifying a portion of content that the user may wish to return to during a reading session.

The correlation module 216 may also determine the device usage context further based upon extrinsic sensor data from one or more extrinsic sensor(s). Extrinsic sensor data may be received via transmitter 230. For example, the correlation module 216 may determine that a user and an additional user are collaboratively editing a document on the electronic device 102 based on a correlated grip/mobility event. The correlation module 216 may further determine an identity of the additional user based upon data from a wearable sensor (e.g., smart watch) worn by the additional user. Such identification may also be performed purely based upon a correlated grip/mobility event. The determination of device usage context may be further based on other extrinsic data such as Bluetooth data, user calendar information, meeting invite lists, data from external sensors, social media, etc.

Training module 224 may be executable by the one or more processors 204 to cause one or more processors 204 to train model 218. The training module 224 may use sensor data 210 and other information associated with an electronic device 102 and/or and one or more additional electronic devices 110 (e.g., subsequent user action, interaction with one or more additional electronic devices 110, etc.), to modify the model (such as by e.g., based upon receiving data indicative of a previously determined device usage context being incorrect, the training module may modify associated training data to minimize similar errors in the future).

The training module 224 may also use sensor data 210 and other information associated with a particular user (e.g., user actions of the particular user, the particular user's interaction with an additional electronic device, etc.) to generate a corpus of user specific training data 222 for the particular user. In this way, over time user specific training data 22 may be built that takes into account idiosyncratic grips and motions that are unique to specific users of an electronic device. Additionally, in some examples the user specific training data 222 may also take into account the idiosyncratic grips and motions that users utilize in specific locations, in particular social contexts, among users having a particular social relationships/work hierarchy, etc.

The action module 226 may be executable by the one or more processors 204 to cause, based at least on the usage context determined by the correlation module 216, one or more processors 204 to cause an action to be performed by one of the electronic device 102, or one or more additional electronic devices 110. The action module 226 may cause an internal change in a state on one or more of the electronic device 102 and/or additional electronic device(s) 110, such as an internal change in state of an OS, of another application (e.g., web browser, or other), and/or a device driver software, and/or firmware; some or all of which may result in and/or cause device peripheral hardware to perform an action by passing a command through an appropriate data structure to an OS or, which may cause through a device driver to cause hardware on the device to perform some action, such as via one or more electrical signals from I/O interfaces to the peripheral hardware. For example, the transmitter may be passed, through a data communication protocol stack, data to be transmitted and an instruction to transmit the data. The display 228 may receive updated display data via a display driver software.

For example, based upon the correlation module 216 determining a device usage context that indicates with sufficient likelihood that a user is identifying a portion of content that the user may wish to return to, the action module 226 may cause a bookmark to be created for that portion of content. Creating the bookmark may include storing the bookmark in the memory 208, modifying a GUI displayed on a display 228 of the electronic device 102, and/or on an additional electronic device, and so forth. Also, a subsequent user action, including one or more of a user selection, a user grip event, or micro-mobility event (e.g., a tilting of the device, flipping of the device, etc.), or determining of a subsequent usage context by the correlation module 216, may cause the electronic device 102 to perform another action such as presenting the bookmarked content on a display 228 of the electronic device 102, presenting a visual cue on the GUI that a further action can cause the bookmarked content to be displayed, presenting a selectable option to have the bookmarked content displayed on the GUI, etc. In another example, based on a device usage context of a content reading session, the electronic device 102 may cause a next portion of the content being read to be pre-fetched, so that it is more quickly available to the user.

The processor(s) 204 may be configured to execute instructions, applications, or programs stored in the memory 208. In some examples, the processor(s) 204 may include hardware processors that include, without limitation, a hardware central processing unit (CPU), a graphics processing unit (GPU), a field programmable gate array (FPGA), a complex programmable logic device (CPLD), an application specific integrated circuit (ASIC), a system-on-chip (SoC), or a combination thereof.

The memory 208 is an example of computer-readable media. Computer-readable media may include two types of computer-readable media, namely computer storage media and communication media. Computer storage media may include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read-only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that may be used to store the desired information and which may be accessed by a computing device, such as electronic device 102, additional electronic devices 110, or servers 114. In general, computer storage media may include computer-executable instructions that, when executed by one or more processors, cause various functions and/or operations described herein to be performed.

In contrast, communication media embody computer-readable instructions, data structures, program modules, or other data in a modulated data signal, such as a carrier wave, or other transmission mechanism. As defined herein, computer storage media does not include communication media.

Additionally, the transmitter 230 includes physical and/or logical interfaces for connecting the respective computing device(s) to another computing device or a network. For example, the transmitter 230 may enable WiFi-based communication such as via frequencies defined by the IEEE 802.11 standards, short range wireless frequencies such as Bluetooth®, or any suitable wired or wireless communications protocol that enables the respective computing device to interface with the other computing devices.

The architectures, systems, and individual elements described herein may include many other logical, programmatic, and physical components, of which those shown in the accompanying figures are merely examples that are related to the discussion herein.

### Example Process for Utilizing Correlated Grip/Mobility Events

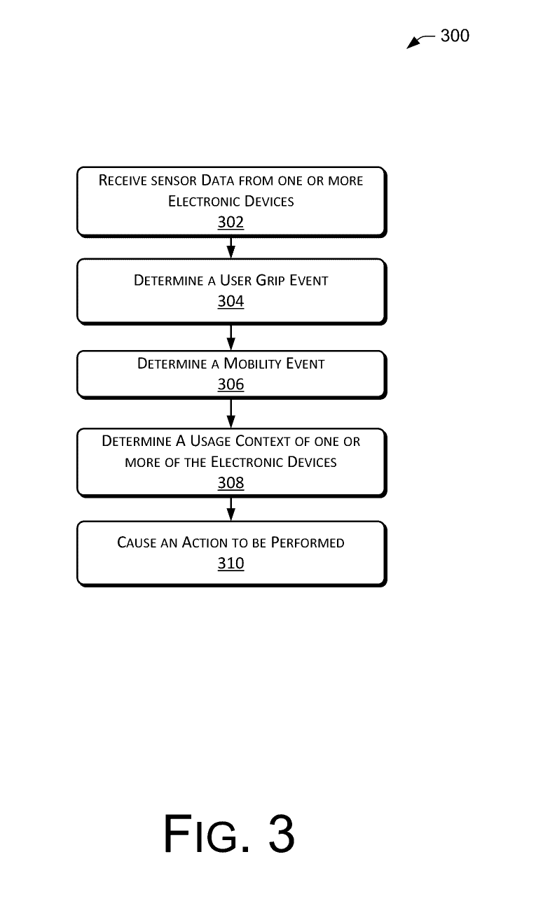

FIG. 3 is flow diagram of an example process 300 utilizing correlated grip/mobility events to support a broad range of interactions and contextually-dependent techniques. One or more steps of process 300 may be performed by a service over a backend content delivery network (i.e. the cloud), as a local process by an electronic device, as a local process by additional electronic device(s), or by a combination thereof.

As shown in FIG. 3, at operation 302, an electronic device receives sensor data from one or more of electronic devices. The sensor data may be received from one or more of sensor hardware of the electronic devices, and extrinsic sensors.

At operation 304, the electronic device determines a user grip event. Determining a user grip event may include one or more of a determination of a type of grip event (e.g., a thumb grip, a finger grip, a tray grip, etc.), a completeness of a grip (e.g., a partial grip, a full handed grip, a pinch grip, pressure grip, etc.), and a location of the grip (e.g., on the bezel of the device, on a top right corner of the device, covering a portion of a display, etc.). Identifying the occurrence of the user grip event may also include identifying multiple user grip events based on the sensor data, and/or a change in a user grip event. Identifying the occurrence of the user grip event may also include pre-processing of the raw sensor data to filter out sensor noise, or post-processing of the recognized grip types to stabilize jittery grip status changes.

At operation 306, the electronic device determines a mobility event. Determining the occurrence of a mobility event may include determining a rotation and/or repositioning of the electronic device during a user interaction with an electronic device (e.g., drawing a device closer to a user, swinging a device around an axis, rotating a device, shaking a device, holding a device still, any combinations thereof, etc.). The mobility event may be associated with the electronic device, or with additional electronic device(s).

At operation 308, the electronic device determines a usage context of one or more of the electronic devices. Determining the usage context of the one or more electronic devices may include determining a device usage context associated with a correlated grip/mobility event. Determining the state of the one or more electronic devices may also include correlating one or more grip events and motion events (e.g., by location, time, order, etc.). The correlation may be performed using a corpus of user training data. The usage context of the one or more electronic device may also be determined based partly on extrinsic sensor data from one or more extrinsic sensor(s).

At operation 310, the electronic device causes an action to be performed. Potential actions may be performed by one or more of the electronic devices, and may include an internal change in a state on one or more of the electronic devices, such as but not limited to a user interface action, a system action, an application specific action, etc.

### Example System for Utilizing Correlated Grip/Mobility Events in a Single Device, Multiple User Interaction

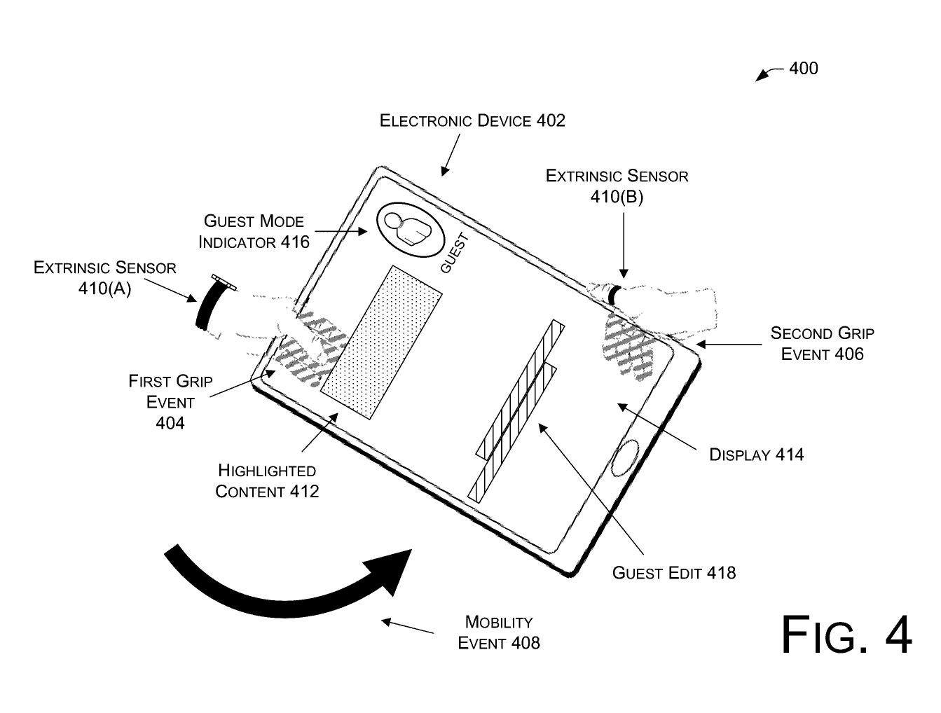

FIG. 4 illustrates an example system where correlated grip/mobility events are used to support interactions and contextually-dependent techniques in a single device, multiple user interaction. FIG. 4 shows representative electronic device 402 in the forms of a tablet computer. However, this is merely an example, and the electronic device 402 according to this application may take other forms. Moreover, FIG. 4 shows an example system that includes two grip events and one motion event. However, this is merely an example, and systems according to this application may include one or more additional grip events and/or motion events.

FIG. 4 illustrates a first grip event 404, and a second grip event 406 associated with the electronic device 402. The first grip event 404 may be associated with a first user, and the second grip event 406 may be associated with a second user. The first grip event 404, and the second grip event 406 may each be characterized by a type of grip event (e.g., a thumb grip, a finger grip, a tray grip, etc.), a completeness of a grip (e.g., a partial grip, a full handed grip, a pinch grip, pressure grip, etc.), and a location of the grip (e.g., on the bezel of the device, on a top right corner of the device, covering a portion of a display, etc.). FIG. 4 also illustrates a mobility event 408. The mobility event 408 may be characterized by a rotation and/or repositioning of the electronic device 402 (e.g., drawing a device closer to a user, swinging a device around an axis, rotating a device, shaking a device, holding a device still, any combinations thereof, etc.).

By correlating the first grip event 404, the second grip event 406, and the mobility event 408, the electronic device (or another electronic device, server resource, etc.) may determine a usage context of the electronic device 402. The determination of usage context may be further informed by sensor data from one or more extrinsic sensors 410, such as cameras, microphones, smartwatches, sensor bands, Bluetooth sensors, etc.

Based on the determined usage context of the electronic device 402, one or more actions may be performed. Potential actions may include an internal change in a state on one or more of the electronic devices, such as but not limited to a user interface action, a system action, an application specific action, etc. For example, based on the usage context of the electronic device 402, an action may be performed to emphasize or highlight content 412 on a display 414 of the electronic device 402. Another potential action may include causing the electronic device 402 to operate in a different mode, such as a guest mode or a collaboration mode. Operating in a different mode may cause the electronic device 402 to change security settings, provide a new or modified GUI, provide a visual indicator 416 of the mode of operation, launch an application, provide additional tools/functionalities etc. For example, when operating in a collaborative mode, the electronic device 402 may record edits made 418 by the second user. The electronic device 402 may also associate edits with a particular user, and/or display edits such that they are differentiated according to the user that performed the edit.

### Example Process for Utilizing Correlated Grip/Mobility Events in a Single Device, Multiple User Interaction

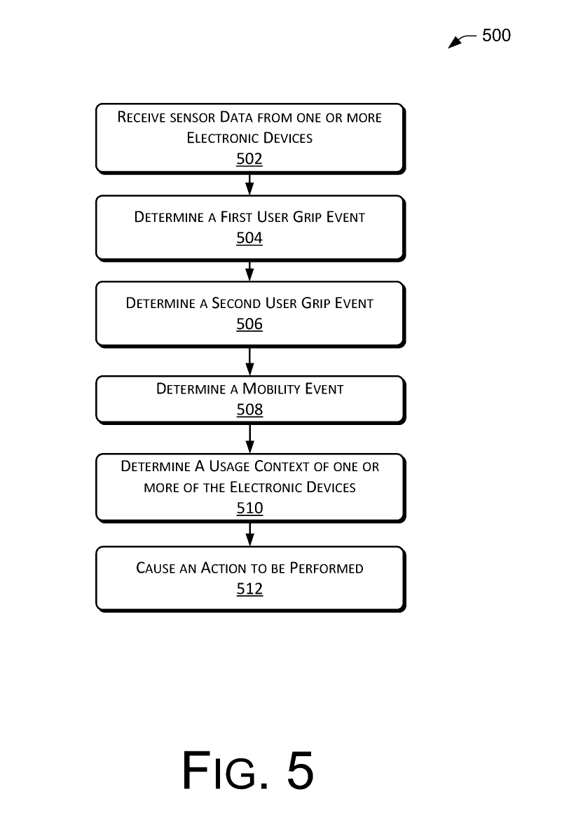

FIG. 5 is a flow diagram of an example process 500 for utilizing correlated grip/mobility events to support interactions and contextually-dependent techniques in a single device, multiple user interaction. One or more steps of process 500 may be performed by a service over a backend content delivery network (i.e. the cloud), as a local process by an electronic device, as a local process by an additional electronic device, or by a combination thereof.

As shown in FIG. 5, at operation 502, the electronic device receives sensor data from one or more of electronic devices. The sensor data may be received from one or more of sensor hardware of the electronic devices, and extrinsic sensors.

At operation 504, the electronic device determines a first user grip event. Determining the first user grip event may include one or more of a determination of a type of grip event (e.g., a thumb grip, a finger grip, a tray grip, etc.), a completeness of a grip (e.g., a partial grip, a full handed grip, a pinch grip, pressure grip, etc.), and a location of the grip (e.g., on the bezel of the device, on a top right corner of the device, covering a portion of a display, etc.). Determining the first user grip event may further include identifying a particular user (or a user account associated with the particular user) that is associated with the first user grip event. For example, the particular user may be identified based upon one or more of unique grip patterns exhibited by the particular user, user specific training data, extrinsic sensors (i.e. microphones, smartwatches, cameras, etc.), and/or other information (e.g., calendar information, social media, etc.).

At operation 506, the electronic device determines a second user grip event. Determining the second user grip event may include one or more of a determination of a type of grip event, a completeness of a grip, and a location of the grip. Determining the second user grip event may also include determining a grip even in which a second user does not directly touch the device (i.e., is about to touch the device, a gesture by the second user, etc.). For example, the electronic device may determine a grip event based on sensor data including but not limited to, data indicative of an impending touching of the device (i.e., from a hover sensor, etc.). Determining the second user grip event may further include identifying a second particular user (or a second user account associated with the second particular user) that is associated with the second user grip event. The second user grip event may be associated with the electronic device, or with one or more additional electronic device(s).

At operation 508, the electronic device determines a mobility event. Determining the occurrence of the mobility event may include determining a rotation and/or repositioning of the electronic device during a user interaction with an electronic device (e.g., drawing a device closer to a user, swinging a device around an axis, rotating a device, shaking a device, holding a device still, any combinations thereof, etc.). The mobility event may be associated with the electronic device, or with one or more additional electronic device(s).

At operation 510, the electronic device determines a usage context of one or more of the electronic devices. Determining the usage context of the one or more electronic devices may include determine a device usage context associated with a correlated grip/micro-mobility event. Determining the usage context of the one or more electronic devices may also include correlating one or more grip events and motion events (e.g., by location, time, order, etc.). For example, an electronic device may determine that a first user employing a thumb grip proximate to particular content, correlated with a second user employing thumb grip in a different territorial region of the device, and a swing of the device around the first user's grip corresponds to a device usage context where the first user is showing the particular content to the second user. In another example, the electronic device may determine that a first user and a second user each employing symmetrical thumb grips on opposite bezels of the electronic device correlated with a prolonged stillness of the device corresponds to the device usage context of the device being used to collaboratively edit the document. The electronic device may also determine from capacitance sensor data, accelerometer data, etc., that a first user employing a thumb grip, correlated with a second user employing thumb grip in a larger territorial region of the device, and a swing of the device around the first user's grip corresponds to a device usage context where the first user is handing the electronic device to the second user.

The correlation and determination of device usage context may be performed using one or more corpora of user training data, or using one or more corpuses of user specific training data that are associated with users associated with the correlated grip/mobility event. For example, a grip/mobility correlation that generally describes a first device usage context, may correspond to a second device usage context in the context of a particular user or combination of users.

The correlation and determination of device usage context may also be further based on additional information such as a time of day, location of the device, an identity of the first user and/or the second user, user profile information, a calendar of a user, content on the device, etc. For example, the service 106 may consider the type of meeting and profile information relating to the users to determine that a handing of the device from a first user to a second user does or does not correspond to a collaborative editing session (e.g., by determining that the handing of the device occurred in a classroom during a scheduled class and was between a student and a teacher, the electronic device may determine that the usage context of the device is a sharing of content, and not an invitation for edits from the student).

At operation 512, the electronic device causes an action to be performed. Potential actions may be performed by one or more of the electronic devices, and may include an internal change in a state on one or more of the electronic devices, such as but not limited to a user interface action, a system action, an application specific action, etc. For example, upon determining a device usage context of the first user showing particular content to the second user, the electronic device may perform an action to emphasize the particular content (e.g., enlarging content, minimizing/hiding other content or display elements, highlighting the content, etc.). In another example, based on a grip even in which a second user is about to touch the device, the electronic device may determine a device usage context that a sharing interaction is about to occur and initiate an animation associated with the sharing interaction.

The electronic device may also cause the action to be performed based on additional information such as a time of day, location of the device, an identity of the first user and/or the second user, user profile information, a calendar of a user, content on the device, etc. For example, the service 106 may consider the type of meeting and profile information relating to the users to determine an appropriate action for the device context (e.g., by determining that the handing of the device occurred in a hospital room during a scheduled appointment and was between a doctor and a patient, the electronic device may hide information that is not appropriate for the patient to see, and or otherwise bias the sharing experience so that the doctor remains in control of the interaction).

The electronic device may also operate in a different mode, such as a collaborative mode, guest mode, or mode associated with the second user based upon the device usage contexts. When operating in a different mode, the electronic device may change security settings, provide a new or modified GUI, provide a visual indicator of the mode of operation, launch an application, provide additional tools/functionalities etc. For example, when operating in a collaborative mode, the electronic device may record edits made by the second user. The electronic device may also associate edits with a particular user, and/or display edits such that they are differentiated according to the user that performed the edit.

### Example System for Utilizing Correlated Grip/Mobility Events in a Multiple Device, Single User Interaction

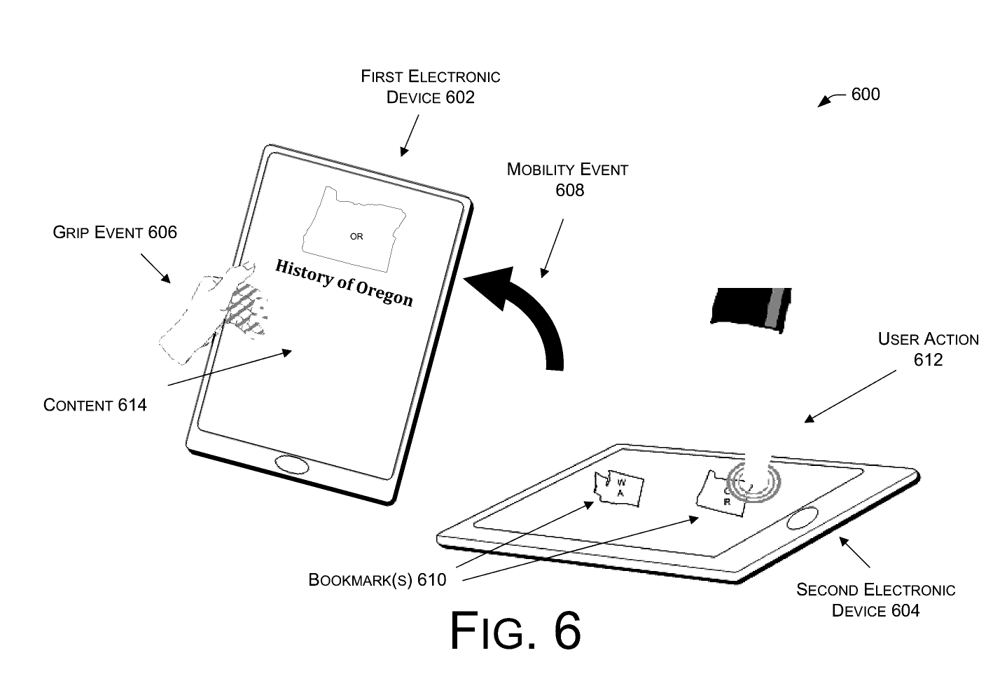

FIG. 6 illustrates an example system 600 that uses correlated grip/mobility events to support interactions and contextually-dependent techniques in a multiple device, single user interaction. FIG. 6 shows representative electronic devices in the form of tablet computers. However, this is merely an example, and the electronic devices according to this application may take other forms.

FIG. 6 illustrates a first electronic device 602, and a second electronic device 604. FIG. 6 also illustrates a grip event 606 and a mobility event 608 associated with a first electronic device 602. One or more bookmarks 610, icons, links, selectable elements, content, etc., may be displayed on the second electronic device 604. A user action 612 may be associated with the second electronic device 604. For example, a user may select a bookmark 610. A user action may also include a grip event, a motion event, a pressure/selection of a region of a display/casing/bezel of the second electronic device, etc. The user action 612 associated with the second electronic device 604 may cause content 614 to be displayed on the first electronic device 602.

### Example Process for Utilizing Correlated Grip/Mobility Events in a Multiple Device, Single User Interaction

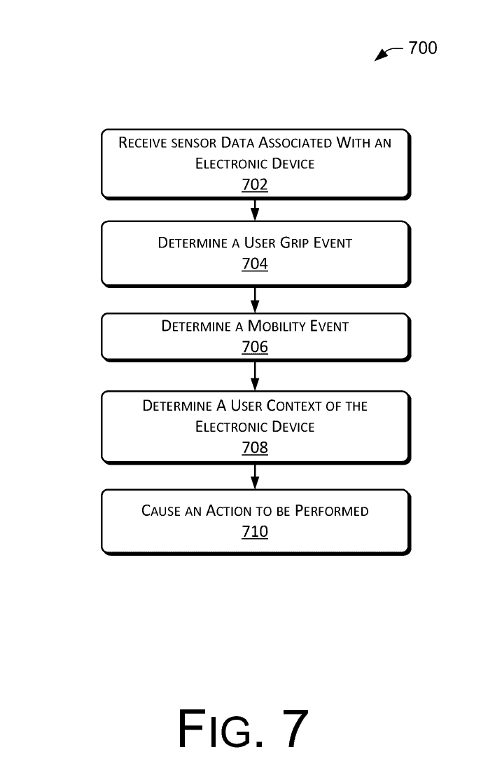

FIG. 7 is a flow diagram of an example process 700 for utilizing correlated grip/mobility events to support interactions and contextually-dependent techniques in a multiple device, single user interaction. One or more steps of process 700 may be performed by a service over a backend content delivery network (i.e. the cloud), as a local process by an electronic device, as a process by an additional electronic device, or by a combination thereof.

As shown in FIG. 7, at operation 702, the electronic device receives sensor data associated with the electronic device. The sensor data may be received from one or more of sensor hardware of the electronic device, and extrinsic sensors.

At operation 704, the electronic device determines a user grip event. Determining the user grip event may include one or more of a determination of a type of grip event (e.g., a thumb grip, a finger grip, a tray grip, etc.), a completeness of a grip (e.g., a partial grip, a full handed grip, a pinch grip, pressure grip, etc.), and a location of the grip (e.g., on the bezel of the device, on a top right corner of the device, covering a portion of a display, etc.). Determining the user grip event may further include identifying a particular user (or a user account associated with the particular user) that is associated with the user grip event. For example, the particular user may be identified based upon one or more of unique grip patterns exhibited by the particular user, user specific training data, extrinsic sensors (i.e. microphones, smartwatches, depth cameras, cameras, etc.), or other information (e.g., calendar information, social media, etc.).

At operation 706, the electronic device determines a mobility event. Determining the occurrence of the mobility event may include determining a rotation and/or repositioning of the electronic device during a user interaction with the electronic device (e.g., drawing a device closer to a user, swinging a device around an axis, rotating a device, shaking a device, holding a device still, any combinations thereof, etc.).

At operation 708, the electronic device determines a usage context of the electronic device. Determining the usage context of the electronic device may also include correlating one or more grip events and motion events (e.g., by location, time, order, etc.), and then determining a device usage context associated with a correlated grip/mobility event. For example, the electronic device may determine that a user employing a thumb grip correlated with a tilting raise of one edge of a first user device off of a surface corresponds to a device usage context where the user is reading or browsing content on the first electronic device. The electronic device may also determine that a partial grip event (e.g., a pinch, three finger grip, etc.) in a region proximate to content being displayed on the first electronic device corresponding to a short period of stillness of the electronic device corresponds to a device usage context where the user is selecting the content being displayed in the region proximate to the grip event.

The correlation and determination of device usage context may be performed using one or more corpora of user training data, or may be performed using one or more corpuses of user specific training data that are associated with a user associated with the correlated grip/micro-mobility event. For example, a grip/mobility correlation that generally describes a first device usage context, may correspond to a second device usage context in the context of a particular user.

At operation 710, the electronic device causes an action to be performed. Potential actions may be performed by one or more of the electronic devices, and may include any of a user interface action, a system action, an application specific action, etc. For example, upon determining that the device usage context of a first electronic device corresponds to a user selecting content being displayed in the region proximate to a grip event, a second electronic device may display the selected content. The user may then use the second electronic device to perform edits, create bookmarks, save portions of data or perform other operations with the content.

Actions may also be performed based upon user actions in combination with a correlated grip/mobility event. For example, the electronic device may determine that a grip/mobility event corresponds to a device usage context where a user is reading or browsing content on the first electronic device. The electronic device may then cause, based further upon receiving a selection of a bookmark, content item, selectable option, link, etc. via a second electronic device may cause the first electronic device to display content associated with the selection.

### Example System for Utilizing Correlated Grip/Mobility Events in a Multiple Device, Multiple User Interaction

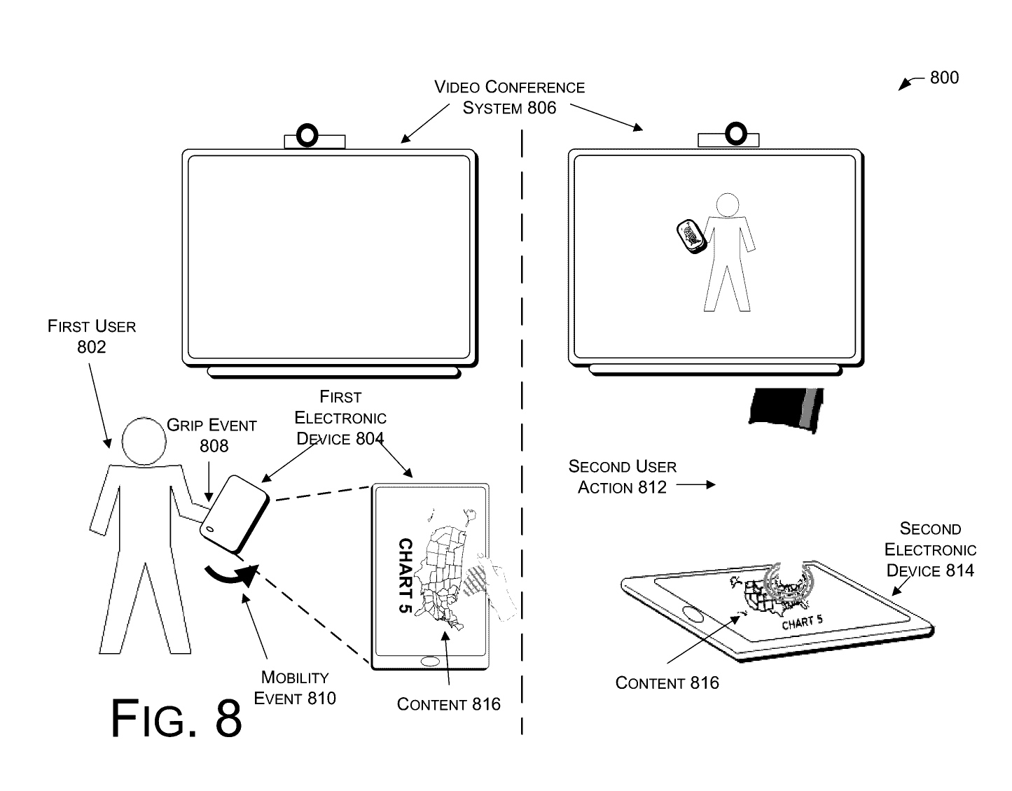

FIG. 8 illustrates an example diagram where correlated grip/mobility events are used to support interactions and contextually-dependent techniques in a multiple device, multiple user interaction. FIG. 8 shows representative electronic devices in the form of tablet computers. However, this is merely an example, and the electronic devices according to this application may take other forms.

FIG. 8 illustrates a first user 802 associated with a first electronic device 804 during a multi-user meeting over a video conference system 806. FIG. 8 also illustrates a grip event 808 and a micro-mobility event 810 associated with the first electronic device 804. Based upon a correlation of the grip event 808 and the micro-mobility event 810, a device usage context of the first electronic device 804 can be determined. For example, it may be determined by one or more computing devices (i.e., the first electronic device, second electronic device, another electronic device, videoconference system, cameras or depth cameras in the room, server, cloud service, etc.) that the correlated grip/mobility event corresponds to a device usage context where the first user 802 is showing content displayed on the first electronic device 804 to a second user.

A second user action 812 is shown associated with the second electronic device 814. A user action may include a grip event, a motion event, a pressure/selection of a region of a display/casing/bezel of the second electronic device, etc. The second user action 812 associated with the second electronic device 814 may, in conjunction with the correlated grip/mobility event, cause content 816 to be displayed on the second electronic device 814. For example, in a situation where a correlated grip/mobility event is determined to correspond to a first user 802 showing particular content displayed on a first electronic device 804 to a second user 812, remote from the first user 802, a user action associated with a second electronic device may cause the content 816 to be displayed on the second electronic device 814.

### Example Process for Utilizing Correlated Grip/Mobility Events in a Multiple Device, Multiple User Interaction

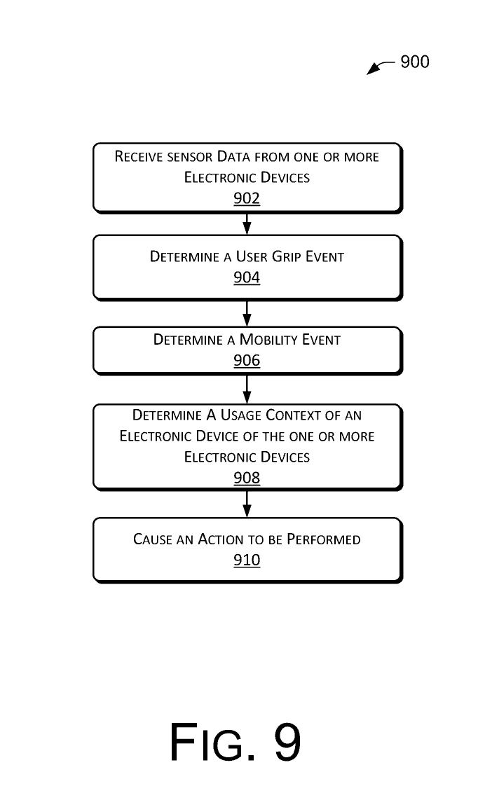

FIG. 9 is a flow diagram of an example process 900 for leveraging correlated grip/mobility events to support interactions and contextually-dependent techniques in a multiple device, multiple user interaction. One or more steps of process 900 may be performed by a service over a backend content delivery network (i.e. the cloud), as a local process by an electronic device, as a process by an additional electronic device, or by a combination thereof.

As shown in FIG. 9, at operation 902, the electronic device receives sensor data from one or more electronic devices. The sensor data may be received from one or more of sensor hardware of the one or more electronic devices, and/or from one or more extrinsic sensors.

At operation 904, the electronic device determines a user grip event. Determining the user grip event may include one or more of a determination of a type of grip event (e.g., a thumb grip, a finger grip, a tray grip, etc.), a completeness of a grip (e.g., a partial grip, a full handed grip, a pinch grip, pressure grip, etc.), and a location of the grip (e.g., on the bezel of the device, on a top right corner of the device, covering a portion of a display, etc.). Determining the user grip event may further include identifying a particular user (or a user account associated with the particular user) that is associated with the user grip event. For example, the particular user may be identified based upon one or more of unique grip patterns exhibited by the particular user, user specific training data, extrinsic sensors (i.e. microphones, smartwatches, depth cameras, cameras, etc.), or other information (e.g., calendar information, social media, etc.). Determining the user grip event may also include determining a grip event in which one of the user and/or a second user does not directly touch the device (i.e., is about to touch the device, a gesture by the second user, etc.).

At operation 906, the electronic device determines a mobility event. Determining the occurrence of the mobility event may include determining a rotation and/or repositioning of the electronic device during a user interaction with the electronic device (e.g., drawing a device closer to a user, swinging a device around an axis, rotating a device, shaking a device, holding a device still, any combinations thereof, etc.).

At operation 908, the electronic device determines a state of an electronic device of the one or more electronic devices. Determining the state of the electronic device may also include correlating one or more grip events and mobility events (e.g., by location, time, order, etc.), and then determining a device usage context associated with a correlated grip/mobility event. For example, the electronic device may determine that a user employing dual pressure grips located on opposite bezels of a first electronic device correlated a rotation of the first electronic device corresponds to a device usage context where the user showing content displayed on the electronic device to one or more people. The electronic device may also determine that a partial grip event (e.g., three finger grip, etc.) in a region proximate to a user edit displayed on the first electronic device correlated with a rotation of the first electronic device to face a second user corresponds to a device usage context where the user is showing the user edit to the second user. The electronic device may also identify if the second user is local or remote. In some examples, the orientation or surrogate of each remote participant may be sensed using one or more of onboard sensors on a surrogate, extrinsic sensors, sensors internal to one or more additional devices, the videoconference system, etc., and may be used to determine which of the one or more additional users (local, remote, or a combination thereof) are to be shown the user edit.

The correlation and determination of device usage context may be performed using a corpus of user training data, or may be performed using one or more corpuses of user specific training data that are associated with a user associated with the correlated grip/mobility event. For example, a grip/mobility correlation that generally describes a first device usage context, may correspond to a second device usage context in the context of a particular user.

At operation 910, the electronic device causes an action to be performed. Potential actions may be performed by one or more of the electronic devices, and may include any of a user interface action, a system action, an application specific action, etc. For example, upon determining that the device usage context of a first electronic device corresponds to user is showing the user edit to the second user, a second electronic device associated with the second user may display the user edit. The second user device may also prompt the second user for approval or feedbacks related to the user edit, and/or provide a functionality to perform additional edits to share with the first user.

Actions may also be performed based upon user actions associted with a correlated grip/mobility event. For example, the electronic device may determine that a grip/mobility event corresponds to a device usage context where a first user is sharing particular content with a second user (such as by e.g., a change of a grip of the user from a full grip located at a first location of the electronic device to a partial grip at a second location of the electronic device proximate to the portion of content correlated with a swing of the device to face the second user), and based partly upon a user action associated with the second user (such as by e.g., the second user applying pressure to a portion of the second electronic device, selecting a selectable option on the display of the second electronic device, the second user making a gesture, etc.), the second electronic device may display the particular content.

The processes 300, 500, 700, and 900 are described with reference to the environment 100 and system 200 of FIGS. 1 and 2 for convenience and ease of understanding. However, the processes 300, 500, 700, and 900 are not limited to being performed using the environment 100 and system 200. Moreover, the environment 100 and system 200 are not limited to performing the processes 300, 500, 700, and 900.

The processes 300, 500, 700, and 900 are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process may be omitted entirely. Moreover, the processes 300, 500, 700, and 900 may be combined in whole or in part.

The various techniques described herein may be implemented in the context of computer-executable instructions or software, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### EXAMPLE CLAUSES

### Example A

A computing system, comprising at least one processing unit, and memory configured to be in communication with the at least one processing unit, the memory storing instructions that based on execution by the at least one processing unit, cause the at least one processing unit to: receive sensor data from at least one electronic device, determine, based at least partly on the sensor data, a hand grip placement associated with the at least one electronic device, determine, based at least partly on the sensor data, a motion associated with the at least one electronic device, determine, based at least partly on the hand grip placement and the motion, a usage context of the at least one electronic device, and cause an action to be performed based on the usage context of the at least one electronic device.

### Example B

The computing system of example A, wherein the hand grip placement and the motion are each associated with a first electronic device of the at least one electronic device.

### Example C

The computing system of example B, wherein the action is caused to be performed on a second electronic device of the at least one electronic device.

### Example D

The computing system of any of examples A through C, wherein the hand grip placement is a first hand grip placement associated with a first user, wherein the first hand grip placement is associated with a first electronic device, and wherein the instructions further cause the at least one processing unit to determine, based at least partly on the sensor data, a second hand grip placement associated with the first electronic device, wherein the second hand grip placement is associated with a second user.

### Example E

The computing system of example D, wherein the instructions further cause the at least one processing unit to determine the usage context based at least further on the second hand grip placement.

### Example F

The computing system of any of examples A through E, wherein the instructions further cause the at least one processing unit to determine a type of hand grip placement, and determine the usage context based at least further on the type of hand grip placement.

### Example G

The computing system of any of examples A through F, wherein the instructions further cause the at least one processing unit to determine an identity of a user associated with the hand grip placement, and wherein determining the usage context of the at least one electronic device is further based at least partly on the identity of the user.

### Example H

The computing system any of examples A through G, wherein the usage context of the at least one electronic device comprises a selection of a portion of content displayed on a first electronic device, and wherein the action comprises causing the portion of content to be displayed on a second electronic device.

### Example I

The computing system of any of examples A through H, wherein the at least one electronic device is part of the computing system.

### Example J

A method comprising receiving sensor data, determining, based at least partly on the sensor data, a hand grip placement associated with the at least one electronic device, determining, based at least partly on the sensor data, a motion associated with the at least one electronic device, determining, based at least partly on the hand grip placement and the motion, a usage context of the at least one electronic device, and causing an action to be performed based on the usage context of the at least one electronic device.

### Example K

The method of example J, wherein the hand grip placement and the motion are each associated with a first electronic device of the at least one electronic device.

### Example L

The method of example K, wherein the action is caused to be performed on a second electronic device of the at least one electronic device.

### Example M

The method of any of examples J through L, wherein the hand grip placement is a first hand grip placement associated with a first user, the first hand grip placement is associated with a first electronic device, and the method further comprises determining, based at least partly on the sensor data, a second hand grip placement associated with the first electronic device, wherein the second hand grip placement is associated with a second user.

### Example N

The method of example M, wherein the action comprises initiating one of a multi-user mode or guest mode on the first electronic device based at least partly on the second hand grip placement.

### Example O

The method of any of examples J through N, wherein determining the hand grip placement further comprises determining a type of hand grip placement, and wherein the usage context is determined based at least further on the type of hand grip placement.

### Example P

The method of any of examples J through O, wherein determining the hand grip placement further comprises determining an identity of a user associated with the hand grip placement, and wherein determining the usage context of the at least one electronic device is further based at least partly on user information associated with the identity of the user.

### Example Q

The method of any of examples J through P, wherein the usage context of the at least one electronic device comprises a collaborative task performance by two or more users, and wherein the action comprises causing the at least one electronic device to operate in a one of a guest mode or a collaboration mode.

### Example R

An electronic device comprising, at least one processing unit, sensing hardware, and memory configured to be in communication with the at least one or more processing unit, the memory storing instructions that in accordance with execution by the at least one processing unit, cause the at least one processing unit to: receive sensor data indicating signals received from the sensing hardware, determine, based at least partly on the sensor data, a hand grip placement associated with the electronic device, determine, based at least partly on the sensor data, a motion associated with the electronic device, determine, based at least partly on the hand grip placement and the motion, an interaction state of the electronic device, and cause an action to be performed on the electronic device based on the interaction state of the electronic device.

### Example S

The computing system of example R, wherein the action includes causing another action to be performed on a second electronic device.

### Example T

The computing system of either of examples R or S, wherein the interaction state of the electronic device indicates that a user of the electronic device is reading content, and wherein the action comprises changing a graphical user interface displayed on the electronic device to remove other content.

### Example U

A computing system, comprising means for receiving sensor data from at least one electronic device, means for determining, based at least partly on the sensor data, a hand grip placement associated with at least one of the at least one electronic device, means for determining, based at least partly on the sensor data, a motion associated with the at least one of the at least one electronic device, means for determining, based at least partly on the hand grip placement and the motion, a usage context of the at least one of the at least one electronic device, and means for causing an action to be performed based on the usage context of the at least one of the at least one electronic device.

### Example V

The computing system of example U, wherein the hand

grip placement and the motion are each associated with a first electronic device of the at least one electronic device.

### Example W

The computing system of example V, wherein the action is caused to be performed on a second electronic device of the at least one electronic device.

### Example X

The computing system of any of examples U through W, wherein the hand grip placement is a first hand grip placement associated with a first user, wherein the first hand grip placement is associated with a first electronic device, and wherein the computing system further comprises means for determining, based at least partly on the sensor data, a second hand grip placement associated with the first electronic device, wherein the second hand grip placement is associated with a second user.

### Example Y

The computing system of example X, wherein the computer system further comprises means for determining the usage context based at least further on the second hand grip placement.

### Example Z

The computing system of any of examples U through Y, wherein the computer system further comprises means for determining a type of hand grip placement, and means for determining the usage context based at least further on the type of hand grip placement.

### Example AA

The computing system of any of examples U through Z, wherein the computer system further comprises means for determining an identity of a user associated with the hand grip placement, and wherein determining the usage context of the one or more electronic devices is further based at least partly on the identity of the user.

### Example AB

The computing system any of examples U through AA, wherein the usage context of the at least one of the at least one electronic device comprises a selection of a portion of content displayed on a first electronic device, and wherein the action comprises causing the portion of content to be displayed on a second electronic device.

### Example AC

The computing system of any of examples U through AB, wherein the at least one electronic device is part of the computing system.

### Example AD

A method comprising, receiving data corresponding to at least one grip event and at least one motion event, determining, based at least partly on the data, at least one correlated grip and motion event, and determining, based at least partly on the at least one correlated grip and motion event, a usage context of a first electronic device.

### Example AE

The method of example AD, further comprising causing an action to be performed based on the usage context of the electronic device.

### Example AF

The method of example AE, wherein the action is caused to be performed on at least one of the first electronic device and a second electronic device.

### Example AG

The method of either one of examples AE and AF, wherein the action being caused to be performed is further based on a user action.

### Example AH

The method of any of examples AD through AG, wherein the data corresponding to at least one grip event and at least one motion event is associated with the first electronic device.

### Example AI

The method of any of examples AD through AH, wherein the at least one grip event comprises a first hand grip placement associated with a first user, and a second hand grip placement associated with a second user.

### Example AJ

The method of example AI, further comprising, causing an action to be performed, the action comprising initiating one of a multi-user mode or guest mode on the first electronic device based at least partly on the second hand grip placement.

### Example AK

The method of any of examples AD through AJ, wherein the data corresponding to at least one grip event and at least one motion event comprises data corresponding to a type of hand grip placement, and wherein the usage context is determined based at least further on the type of hand grip placement.

### Example AL

The method of any of examples AD through AK, further comprising, determining an identity of a user associated with a grip event of the at least one grip event, and wherein determining the usage context of the electronic device is further based at least partly on user information associated with the identity of the user.

### Example AM

The method of any of examples AE, AF, and AJ, wherein the usage context of the electronic device comprises a collaborative task performance by two or more users, and wherein the action comprises causing the electronic device to operate in a one of a guest mode or a collaboration mode.

### Example AN

A computing system comprising: means for receiving sensor data indicating signals received from the sensing hardware, means for determining, based at least partly on the sensor data, a hand grip placement associated with an electronic device, means for determining, based at least partly on the sensor data, a motion associated with the electronic device, means for determining, based at least partly on the hand grip placement and the motion, an interaction state of the electronic devices, and means for causing an action to be performed on the electronic device based on the interaction state of the electronic device.

### Example AO

The computing system of example AQ, wherein the action includes causing another action to be performed on a second electronic device.

### Example AP

The computing system of either examples AN and AO, wherein the interaction state of the electronic device indicates that a user of the electronic device is reading content, and wherein the action comprises changing a graphical user interface displayed on the electronic device to remove other content.

### Example AQ

The computing system of any of claims AN through AP, wherein the hand grip placement is a first hand grip placement associated with a first user, and wherein computing system further comprises means for determining, based at least partly on the sensor data, a second hand grip placement, wherein the second hand grip placement is associated with a second user.

### Example AR

The computing system of example AQ, wherein the computer system further comprises means for determining the usage context based at least further on the second hand grip placement.

### Example AS

The computing system of any of examples AN through AR, wherein the computer system further comprises means for determining a type of hand grip placement, and means for determining the usage context based at least further on the type of hand grip placement.

### Example AT

The computing system of any of examples AN through AS, wherein the computer system further comprises means for determining an identity of a user associated with the hand grip placement, and wherein determining the usage context of the electronic device is further based at least partly on the identity of the user.

### Example AU

The computing system of any of examples AN through AT, wherein the usage context of the electronic device comprises a selection of a portion of content displayed on the electronic device, and wherein the action comprises causing the portion of content to be displayed on a second electronic device.

### Example AV

The computing system of any of examples AN through AU, wherein the electronic device is part of the computing system.

### CONCLUSION

Although the techniques have been described in language specific to structural features and/or methodological acts, it is to be understood that the appended claims are not necessarily limited to the features or acts described. Rather, the features and acts are described as example implementations.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A computing system, comprising:
at least one processing unit; and
memory configured to be in communication with the at least one processing unit, the memory storing instructions that based on execution by the at least one processing unit, cause the at least one processing unit to:
receive sensor data from at least one electronic device;
determine, based at least partly on the sensor data, a hand grip placement associated with the at least one electronic device;
determine, based at least partly on the sensor data, a motion associated with the at least one electronic device;
determine, based at least partly on the hand grip placement and the motion, a usage context of the at least one electronic device; and
cause an action to be performed based on the usage context of the at least one electronic device.

2. The computing system of claim 1, wherein the hand grip placement and the motion are each associated with a first electronic device of the at least one electronic device.

3. The computing system of claim 2, wherein the action is caused to be performed on a second electronic device of the at least one electronic device.

4. The computing system of claim 1, wherein the hand grip placement is a first hand grip placement associated with a first user, wherein the first hand grip placement is associated with a first electronic device, and wherein the instructions further cause the at least one processing unit to determine, based at least partly on the sensor data, a second hand grip placement associated with the first electronic device, wherein the second hand grip placement is associated with a second user.

5. The computing system of claim 4, wherein the instructions further cause the at least one processing unit to determine the usage context based at least further on the second hand grip placement.

6. The computing system of claim 1, wherein the instructions further cause the at least one processing unit to:
determine a type of hand grip placement; and
determine the usage context based at least further on the type of hand grip placement.

7. The computing system of claim 1 wherein the instructions further cause the at least one processing unit to determine an identity of a user associated with the hand grip placement, and wherein determining the usage context of the at least one electronic device is further based at least partly on the identity of the user.

8. The computing system of claim 1 wherein the usage context of the at least one electronic device comprises a selection of a portion of content displayed on a first electronic device, and wherein the action comprises causing the portion of content to be displayed on a second electronic device.

9. The computing system of claim 1 wherein the at least one electronic device is part of the computing system.

10. A method comprising:
receiving sensor data;
determining, based at least partly on the sensor data, a hand grip placement associated with at least one electronic device;
determining, based at least partly on the sensor data, a motion associated with the at least one electronic device;
determining, based at least partly on the hand grip placement and the motion, a usage context of the at least one electronic device; and
causing an action to be performed based on the usage context of the at least one electronic device.

11. The method of claim 10, wherein the hand grip placement and the motion are each associated with a first electronic device of the at least one electronic device.

12. The method of claim 11, wherein the action is caused to be performed on a second electronic device of the at least one electronic device.

13. The method of claim 10, wherein:
the hand grip placement is a first hand grip placement associated with a first user;
the first hand grip placement is associated with a first electronic device; and
the method further comprises determining, based at least partly on the sensor data, a second hand grip placement associated with the first electronic device, wherein the second hand grip placement is associated with a second user.

14. The method of claim 13, wherein the action comprises initiating one of a multi-user mode or guest mode on the first electronic device based at least partly on the second hand grip placement.

15. The method of claim 10, wherein determining the hand grip placement further comprises determining a type of hand grip placement, and wherein the usage context is determined based at least further on the type of hand grip placement.

16. The method of claim 10, wherein determining the hand grip placement further comprises determining an identity of a user associated with the hand grip placement, and wherein determining the usage context of the at least one electronic device is further based at least partly on user information associated with the identity of the user.

17. The method of claim 10, wherein the usage context of the at least one electronic device comprises a collaborative task performance by two or more users, and wherein the action comprises causing the at least one electronic device to operate in a one of a guest mode or a collaboration mode.

18. An electronic device comprising,
at least one processing unit;
sensing hardware; and
memory configured to be in communication with at least one processing unit, the memory storing instructions that in accordance with execution by the at least one processing unit, cause the at least one processing unit to:
receive sensor data indicating signals received from the sensing hardware;
determine, based at least partly on the sensor data, a hand grip placement associated with the electronic device;
determine, based at least partly on the sensor data, a motion associated with the electronic device;
determine, based at least partly on the hand grip placement and the motion, an interaction state of the electronic device; and
cause an action to be performed on the electronic device based on the interaction state of the electronic device.

19. The electronic device of claim 18, wherein the action includes causing another action to be performed on a second electronic device.

20. The electronic device of claim 18, wherein the interaction state of the electronic device indicates that a user of the electronic device is reading content, and wherein the action comprises changing a graphical user interface displayed on the electronic device to remove other content.
